(19) United States
(12) Patent Application Publication
(10) Pub. No.: US 2020/0033212 A1
(43) Pub. Date: Jan. 30, 2020

(54) PRESSURE SENSOR

(71) Applicant: MIKUNI CORPORATION, Tokyo (JP)

(72) Inventors: Tomoya SATO, Iwate (JP); Katsuhiko FUKUI, Iwate (JP)

(73) Assignee: MIKUNI CORPORATION, Tokyo (JP)

(21) Appl. No.: 16/520,346

(22) Filed: Jul. 23, 2019

(30) Foreign Application Priority Data
Jul. 25, 2018 (JP) 2018-138953

(51) Int. Cl. G01L 9/00; G01L 19/14

(52) U.S. Cl. CPC G01L 9/008; G01L 19/147

(57) ABSTRACT

A pressure sensor is provided. Provided is a pressure sensor including a tubular housing which defines an axial line, a diaphragm which is fixed to a tip end of the housing and exposed to a pressured medium, a pressure measurement member which is constituted by a first electrode, a piezoelectric element, and a second electrode which are sequentially stacked in a direction of the axial line from the tip end side inside the housing, and a preload imparting member which is disposed inside the housing and is configured such that a center region centering on the axial line is configured to have a solid form to impart a preload by pressing the pressure measurement member toward the diaphragm.

### CROSS-REFERENCE TO RELATED APPLICATION

This application claims the priority of Japan patent application serial no. 2018-138953, filed on Jul. 25, 2018. The entirety of the above-mentioned patent application is hereby incorporated by reference herein and made a part of this specification.

### BACKGROUND

### Technical Field

The disclosure relates to a pressure sensor that detects a pressure of a pressured medium, and more particularly, to a pressure sensor that detects a pressure of a high temperature pressured medium such as a combustion gas inside a combustion chamber of an engine.

### Description of Related Art

As a pressure sensor of the related art, there has become known a combustion pressure sensor that includes a tubular housing, a diaphragm coupled to a tip end of the housing and integrally having a pressure transmission unit, a piezoelectric element disposed in contact with the diaphragm, a second electrode disposed in contact with the piezoelectric element, an insulating ring disposed in contact with the second electrode, a tubular supporting member disposed in contact with the insulating ring, a cylindrical pressing member imparting a preload to the piezoelectric element in order to increase sensitivity and linearity of the piezoelectric element, and the like, and detects a combustion pressure of a combustion gas in a combustion chamber (for example, Japanese Patent No. 5978073).

In the pressure sensor, the pressing member is formed as a hollow member that accepts the pressure transmission unit of the diaphragm, the piezoelectric element, the second electrode, the insulating ring, and the supporting member in a stacked state, seals the supporting member so as to be immovable, and covers the outer periphery of each of components.

Further, in incorporating work for imparting a preload, a tensile load is applied to the pressing member, and the pressing member and the outer peripheral surface of the pressure transmission unit are fixed using welding, so that a desired preload is imparted to the piezoelectric element.

Here, the pressing member is formed to have a hollow shape and has a structure in which the supporting member and an outer peripheral surface region of the pressure transmission unit are drawn together due to an elastic force in a thin portion of the pressing member so that a preload is exerted on the piezoelectric element in an axial line direction of the housing.

That is, since a preload is not exerted on the axial line of the housing which passes through the center of the diaphragm, pressure resistance may be reduced due to stress concentration in the thin portion of the pressing member, and there is a concern regarding whether a desired preload will be imparted to the piezoelectric element.

In addition, since the pressing member has a hollow shape and the insulating ring also has a ring shape, it is difficult to achieve miniaturization due to the necessity of a hollow on an inner side. Further, since an area for receiving a load is small, there is also concern of a reduction in pressure resistance.

Further, since the pressing member is fixed to the pressure transmission unit also functioning as a first electrode using welding, the pressing member is required to be formed of a metal material. Therefore, when a reduction in the diameter of the pressing member is achieved, clearance between the second electrode disposed inside the pressing member and the pressing member is reduced, and thus there is a concern that an output side (second electrode) and a GND side (pressure transmission unit) may be short-circuited.

### PATENT DOCUMENTS

[Patent Document 1] Japanese Patent No. 5978073

### SUMMARY

An aspect of the disclosure provides a pressure sensor including a tubular housing which defines an axial line, a diaphragm which is fixed to a tip end of the housing and exposed to a pressured medium, a pressure measurement member which is constituted by a first electrode, a piezoelectric element, and a second electrode which are sequentially stacked in a direction of the axial line from a tip end side inside the housing, and a preload imparting member which is disposed inside the housing and is configured such that a center region centering on the axial line is configured to have a solid form to impart a preload by pressing the pressure measurement member toward the diaphragm.

According to an embodiment of the disclosure, in the pressure sensor, the diaphragm includes a flexible plate-shaped portion fixed to the housing and a protrusion portion protruding toward an inside of the housing from a center region of the flexible plate-shaped portion, and the preload imparting member is configured so as to press the pressure measurement member toward the protrusion portion.

According to an embodiment of the disclosure, in the pressure sensor, the preload imparting member includes a fixation member fixed to the housing and an insulating member disposed between the fixation member and the second electrode.

According to an embodiment of the disclosure, in the pressure sensor, the fixation member has a punched portion in an outer peripheral region outside the center region centering on the axial line to allow a conductor, which is connected to the first electrode or the second electrode, to pass therethrough.

According to an embodiment of the disclosure, the pressure sensor further includes a positioning member which is fitted to an inside of the housing. The pressure measurement member is fitted in the positioning member so as to be positioned on the axial line.

According to an embodiment of the disclosure, in the pressure sensor, the preload imparting member includes a fixation member fixed to the housing and an insulating member disposed between the fixation member and the second electrode, and the positioning member is formed of an insulating material and has a tubular shape defining a through hole into which the pressure measurement member and the insulating member are fitted.

According to an embodiment of the disclosure, the pressure sensor further includes a heat-insulating member which is interposed between the diaphragm and the first electrode. The heat-insulating member is fitted into the through hole of the positioning member.

According to an embodiment of the disclosure, in the pressure sensor, the preload imparting member includes a fixation member fixed to the housing and an insulating member disposed between the fixation member and the second electrode, and the positioning member includes an insulating material and has a bottomed tubular shape defining a concave portion into which the pressure measurement member and the insulating member are fitted.

According to an embodiment of the disclosure, the pressure sensor further includes a heat-insulating member which is interposed between the diaphragm and the first electrode. The positioning member serves as the heat-insulating member.

According to an embodiment of the disclosure, in the pressure sensor, the positioning member has a punched portion configured to allow a conductor, which is connected to the first electrode or the second electrode, to pass therethrough.

According to an embodiment of the disclosure, in the pressure sensor, the pressure sensor further includes a positioning member which is fitted to an inside of the housing. The pressure measurement member is fitted in the positioning member so as to be positioned on the axial line. The housing includes an external housing and a sub-housing which is fitted into and fixed to the external housing, and the diaphragm, the positioning member, the pressure measurement member, and the preload imparting member are disposed inside the sub-housing.

### BRIEF DESCRIPTION OF THE DRAWINGS

FIG. 1 is an appearance perspective view illustrating an embodiment of a pressure sensor according to the disclosure.

FIG. 2 is a cross-sectional view along an axial line of the pressure sensor illustrated in FIG. 1.

FIG. 3 is an exploded perspective view of a sensor module included in the pressure sensor illustrated in FIG. 1.

FIG. 4 is a cross-sectional view of the sensor module illustrated in FIG. 3.

FIG. 5 is a cross-sectional view of the sensor module at a position where the sensor module is rotated by 90 degrees around an axial line S with respect to the cross-section illustrated in FIG. 4.

FIG. 6 is a cross-sectional view illustrating an operation of imparting a preload and performing incorporating in the sensor module illustrated in FIG. 3.

FIG. 7 illustrates another embodiment of a pressure sensor according to the disclosure and is an exploded perspective view of a sensor module included in the pressure sensor.

FIG. 8 is a cross-sectional view of the sensor module illustrated in FIG. 7.

FIG. 9 is a cross-sectional view of the sensor module at a position where the sensor module is rotated by 90 degrees around an axial line S with respect to the cross-section illustrated in FIG. 8.

FIG. 10 is a cross-sectional view illustrating an operation of imparting a preload and performing incorporating in the sensor module illustrated in FIG. 7.

FIG. 11 is an appearance perspective view illustrating still another embodiment of a pressure sensor according to the disclosure.

FIG. 12 is a cross-sectional view along an axial line of the pressure sensor illustrated in FIG. 11.

FIG. 13 is an exploded perspective view of a sensor module included in the pressure sensor illustrated in FIG. 12.

FIG. 14 is a cross-sectional view of the sensor module illustrated in FIG. 13.

FIG. 15 is a cross-sectional view of the sensor module at a position where the sensor module is rotated by 90 degrees around an axial line S with respect to the cross-section illustrated in FIG. 14.

FIG. 16 is a cross-sectional view illustrating an operation of imparting a preload and performing incorporating in the sensor module illustrated in FIG. 13.

### DESCRIPTION OF THE EMBODIMENTS

The disclosure provides a pressure sensor capable of improving pressure resistance to impart a desired preload to a piezoelectric element and securing predetermined sensor accuracy.

According to the pressure sensor having the above-described configuration, it is possible to obtain a pressure sensor capable of improving pressure resistance to impart a desired preload to a piezoelectric element and securing predetermined sensor accuracy.

Hereinafter, embodiments of the disclosure will be described with reference to the accompanying drawings.

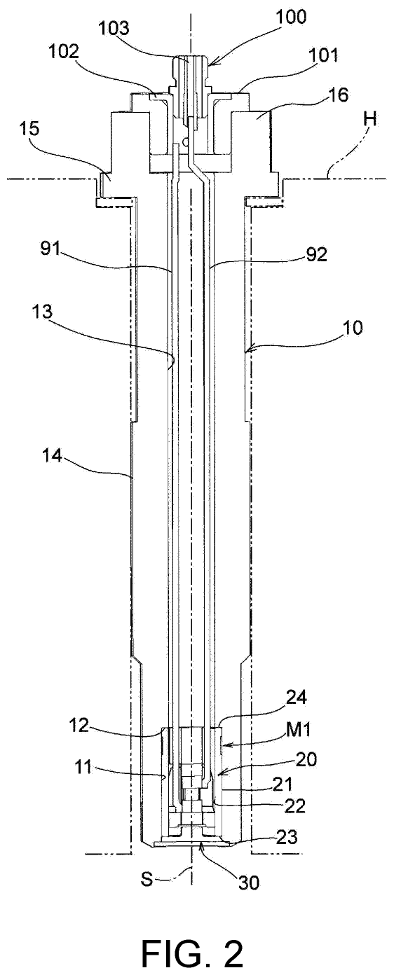

As illustrated in FIG. 2, a pressure sensor according to a first embodiment, which is attached to a cylinder head H of an engine, detects a pressure of a combustion gas inside a combustion chamber as a pressured medium.

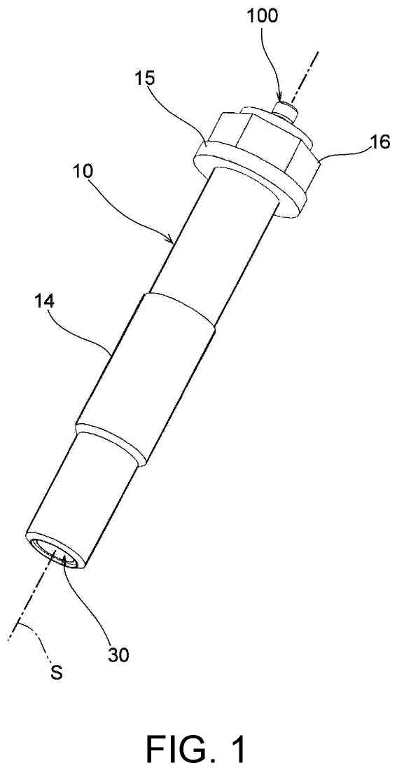

As illustrated in FIGS. 1 to 3, the pressure sensor according to the first embodiment includes an external housing 10 and a sub-housing 20 as tubular housings defining an axial line S, a diaphragm 30, a holding plate 40, a positioning member 50, a heat insulating member 60, a pressure measurement member 70, a preload imparting member 80, lead wires 91 and 92 as conductors, and a connector 100.

The pressure measurement member 70 is constituted by a first electrode 71, a piezoelectric element 72, and a second electrode 73 which are sequentially stacked in a direction of the axial line S from the tip end side of the housing.

The preload imparting member 80 is constituted by a fixation member 81 and an insulating member 82.

As illustrated in FIGS. 1 and 2, the external housing 10 is formed to have a cylindrical shape extending in the direction of the axial line S by using a metal material such as precipitation hardening or ferritic stainless steel, and includes a fitting inner peripheral wall 11, a stepped portion 12, a through passage 13, a male screw portion 14 formed on the outer peripheral surface thereof, a flange portion 15, and a connector connection portion 16.

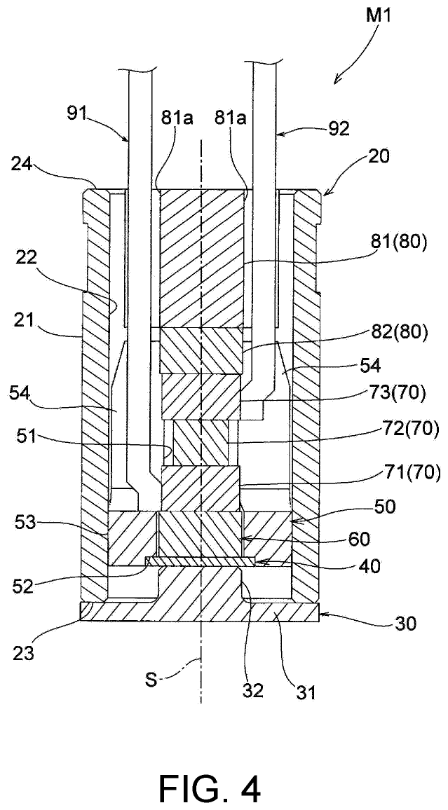

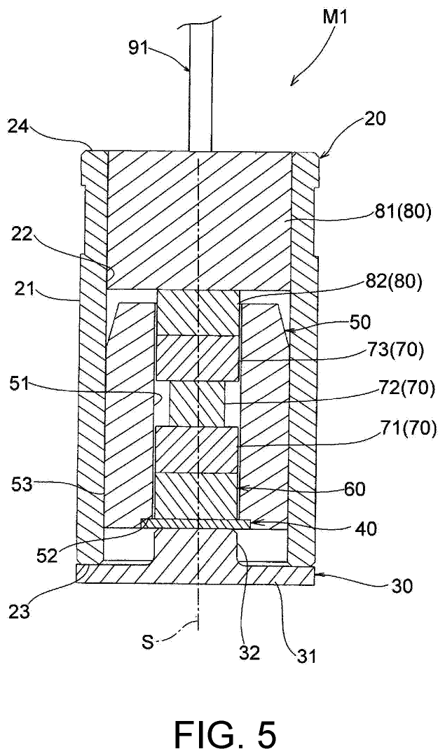

As illustrated in FIGS. 4 and 5, the sub-housing 20 is formed to have a cylindrical shape extending in the direction of the axial line S by using a metal material such as precipitation hardening or ferritic stainless steel, and includes an outer peripheral wall 21 fitted to the fitting inner peripheral wall 11, an inner peripheral wall 22 centering around the axial line S, a tip end surface 23, and a back-side end surface 24.

In addition, the sub-housing 20 is fitted into the inside of the external housing 10 so as to be fixed using welding or the like in a state where the diaphragm 30, the holding plate 40, the positioning member 50, the heat insulating member 60, the pressure measurement member 70, the preload imparting member 80, the lead wire 91, and the lead wire 92 are incorporated thereinto.

As illustrated in FIGS. 4 and 5, the diaphragm 30 is formed using a metal material such as precipitation-hardened stainless steel, and includes a flexible plate-shaped portion 31 and a protrusion portion 32 formed to be continuous with the flexible plate-shaped portion 31.

The flexible plate-shaped portion 31 is formed to have an elastically deformable disk shape, and an outer edge region thereof is fixed to the tip end surface 23 of the sub-housing 20 using welding or the like.

A load corresponding to the pressure of a combustion gas acts on the flexible plate-shaped portion 31, and the flexible plate-shaped portion 31 is elastically deformed in the direction of the axial line S due to the load.

That is, the diaphragm 30 is fixed to the tip end of the sub-housing 20 constituting a portion of the housing and is exposed to a pressured medium.

The protrusion portion 32 is formed to have a columnar shape extending in the direction of the axial line S toward the inside of the sub-housing 20 from a center region of the flexible plate-shaped portion 31 centering on the axial line S.

The outer peripheral surface of the protrusion portion 32 is disposed with an annular gap from the inner peripheral wall 22 of the sub-housing 20.

In addition, the protrusion portion 32 plays a role of transmitting a force received by the flexible plate-shaped portion 31 to the piezoelectric element 72 through the holding plate 40, the heat insulating member 60, and the first electrode 71.

In addition, the protrusion portion 32 is provided, so that a heat transfer amount of heat transferred to the diaphragm 30 is limited by the protrusion portion 32 of which the area is narrowed when the heat is transferred to the inside of the sub-housing 20. Therefore, it is possible to suppress a heat transfer amount moving from the diaphragm 30 to the inside.

As illustrated in FIGS. 4 and 5, the holding plate 40 is formed to have a disk shape having an outer diameter larger than the outer diameter of the protrusion portion 32 by using a metal material such as precipitation hardening or ferritic stainless steel.

In addition, the holding plate 40 is interposed between the protrusion portion 32 of the diaphragm 30 and the heat insulating member 60 to play a role of holding the positioning member 50 so as to be separated from the flexible plate-shaped portion 31 and defining a space between the flexible plate-shaped portion 31 of the diaphragm 30 and the positioning member 50.

Accordingly, it is possible to efficiently suppress heat transfer from the diaphragm 30 to the inside of the housing by the presence of the above-described space.

In addition, the holding plate 40 may be formed of an insulating material or another material as long as it has a high mechanical strength.

As illustrated in FIGS. 4 and 5, the positioning member 50 is formed to have a substantially cylindrical shape extending in the direction of the axial line S by using an insulating material having an electrical insulating property and a thermal insulating property, and includes a through hole 51, a fitting concave portion 52, an outer peripheral surface 53, and two notched grooves 54, as punched portions, which allow the lead wires 91 and 92 to pass through.

The through hole 51 is formed as a circular hole centering on the axial line S and extending in the direction of the axial line S.

The fitting concave portion 52 is formed as a circular concave portion centering on the axial line S in order to accept the holding plate 40.

The outer peripheral surface 53 is formed as a columnar surface centering on the axial line S in order to be fitted to the inner peripheral wall 22 of the sub-housing 20.

The two notched grooves 54 have the same depth dimension in the direction of the axial line S and are provided at positions point-symmetrical to and separated from each other by 180 degrees around the axial line S.

Here, an insulating material for forming the positioning member 50 may have a high heat capacity and a low thermal conductivity. The thermal conductivity is, for example, preferably equal to or less than 15 W/m·K, and more preferably equal to or less than 5 W/m·K. Examples of a specific material include ceramics such as quartz glass, steatite, zirconia, cordierite, forsterite, mullite, and yttria or a conductive material subjected to insulation treatment.

In addition, the positioning member 50, which is supported by the holding plate 40 abutting against the protrusion portion 32 and fitted to the inner peripheral wall 22 of the sub-housing 20, positions and holds the heat insulating member 60, and the pressure measurement member 70 constituted by the first electrode 71, the piezoelectric element 72, and the second electrode 73, and the insulating member 82 in a stacked state inside the through hole 51.

That is, the positioning member 50 is fitted to the inside of the sub-housing 20 constituting a portion of the housing. The heat insulating member 60, the pressure measurement member 70, and the insulating member 82 are fitted in the through hole 51 so as to be positioned on the axial line S.

Therefore, it is possible to position the heat insulating member 60, and the first electrode 71, the piezoelectric element 72 and the second electrode 73 that constitute the pressure measurement member 70 on the axial line S with the positioning member 50 as a reference while securing insulating properties of both the electrodes to easily incorporate these components.

Further, a thermal conductivity of the positioning member 50 may be equal to a thermal conductivity of the heat insulating member 60 and lower than a thermal conductivity of the insulating member 82. Thereby, it is also possible to make the positioning member 50 function as a heat insulating member.

Further, the positioning member 50 is supported by the holding plate 40 and disposed separated from the flexible plate-shaped portion 31 of the diaphragm 30 or is formed to surround the heat insulating member 60, and thus it is possible to efficiently suppress heat transfer from the diaphragm 30 and a wall portion of the housing to the piezoelectric element 72.

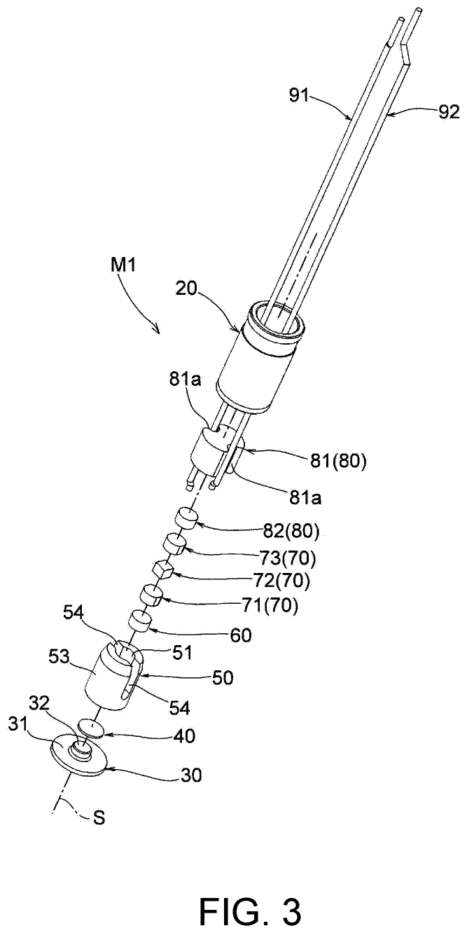

As illustrated in FIGS. 3 to 5, the heat insulating member 60 is formed to have a columnar shape having a predetermined height and an outer diameter equal to the outer diameters of the protrusion portion 32 and the first electrode 71 by using an insulating material having an electrical insulating property and a thermal insulating property.

Here, an insulating material for forming the heat insulating member 60 may have a high heat capacity and a low thermal conductivity. The thermal conductivity is, for example, preferably equal to or less than 15 W/m·K, and more preferably equal to or less than 5 W/m·K. Examples of a specific material include ceramics such as quartz glass, steatite, zirconia, cordierite, forsterite, mullite, and yttria or a conductive material subjected to insulation treatment.

In addition, the heat insulating member 60 is closely disposed between the holding plate 40 abutting against the protrusion portion 32 of the diaphragm 30 and the first electrode 71 inside the sub-housing 20.

Thereby, the heat insulating member 60 functions so as to suppress heat transfer from the diaphragm 30 to the first electrode 71.

That is, a load due to pressure received by the diaphragm 30 is transmitted to the piezoelectric element 72 through the holding plate 40, the heat insulating member 60, and the first electrode 71, and heat transfer from the diaphragm 30 to the first electrode 71 is suppressed by the heat insulating member 60.

Accordingly, the influence of heat on the piezoelectric element 72 adjacent to the first electrode 71 is suppressed, so that it is possible to prevent a fluctuation in a reference point (zero point) of a sensor output and to obtain predetermined sensor accuracy.

The pressure measurement member 70 functions in order to detect a pressure and includes the first electrode 71, the piezoelectric element 72, and the second electrode 73 which are sequentially stacked from the tip end side thereof in the direction of the axial line S inside the sub-housing 20 as illustrated in FIGS. 3 to 5.

The first electrode 71 is formed to have a columnar or disk shape having an outer diameter fitted into the through hole 51 of the positioning member 50 by using a conductive metal material such as precipitation hardening or ferritic stainless steel.

In addition, the first electrode 71 is disposed such that one surface thereof is in close contact with the heat insulating member 60 and the other surface is in close contact with the piezoelectric element 72 inside the through hole 51 of the positioning member 50.

The piezoelectric element 72 is formed in a quadrangular prism shape having dimensions so as not to be in contact with the through hole 51 of the positioning member 50. In addition, the piezoelectric element 72 is disposed such that one surface thereof is in close contact with the first electrode 71 and the other surface is in close contact with the second electrode 73 inside the through hole 51 of the positioning member 50.

Thereby, the piezoelectric element 72 outputs an electrical signal on the basis of distortion due to a load received in the direction of the axial line S.

In addition, as the piezoelectric element 72, ceramics such as zinc oxide (ZnO), barium titanate (BaTiO3), and lead zirconate titanate (PZT), quartz crystal, and the like are applied.

The second electrode 73 is formed to have a columnar or cylindrical shape having an outer diameter fitted into the through hole 51 of the positioning member 50 by using a conductive metal material such as precipitation hardening or ferritic stainless steel.

In addition, the second electrode 73 is disposed such that one surface thereof is in close contact with the piezoelectric element 72 and the other surface is in close contact with the insulating member 82 inside the through hole 51 of the positioning member 50.

As illustrated in FIGS. 3 to 5, the preload imparting member 80, which is disposed inside the sub-housing 20 constituting a portion of the housing, plays a role of pressing the pressure measurement member 70 toward the diaphragm 30 to impart a preload and imparting linear characteristics as a sensor to the pressure measurement member 70, and is constituted by the fixation member 81 and the insulating member 82.

The fixation member 81 is formed to have a substantially solid columnar shape having no hollow or punch in a center region centering on the axial line S and occupying an area equal to or greater than that of the through hole 51 by using a metal material such as precipitation hardening or ferritic stainless steel.

In addition, the fixation member 81 includes two vertical grooves 81a as punched portions in an outer peripheral region deviated from the center region.

The two vertical grooves 81a are formed at positions point-symmetrical to and separated from each other by 180 degrees around the axial line S in order to respectively allow the lead wires 91 and 92 to pass therethrough.

That is, the fixation member 81 is formed such that the center region thereof centering on the axial line S has a solid form, and has a punched portion in the outer peripheral region deviated from the center region.

The insulating member 82 is formed to have a columnar or cylindrical shape having an outer diameter fitted into the through hole 51 of the positioning member 50 by using an insulating material having an electrically high insulating property.

That is, the insulating member 82 is formed to have a solid form having no hollow or punch in the entire region occupying an area equal to that of the through hole 51.

In addition, the insulating member 82 functions to maintain electrical insulation between the second electrode 73 and the fixation member 81 and guide heat transferred to the piezoelectric element 72 to the fixation member 81 to discharge heat.

The insulating material of the insulating member 82 may have a low heat capacity and a high thermal conductivity, and examples of a specific material include ceramics such as alumina, sapphire, aluminum nitride, and silicon carbide or a conductive material subjected to insulation treatment.

Further, the insulating member 82 may have a thermal conductivity higher than a thermal conductivity of the heat insulating member 60, for example, equal to or higher than 30 W/m·K. In addition, the insulating member 82 may have a heat capacity lower than that of the heat insulating member 60. Accordingly, a heat transfer amount transferred to the piezoelectric element 72 can be suppressed by the heat insulating member 60 as much as possible, and heat transferred to the piezoelectric element 72 can be prompted to be discharged through the insulating member 82.

As described above, the preload imparting member 80 constituted by the fixation member 81 and the insulating member 82 is formed such that the center region thereof centering on the axial line S has a solid form, and exerts a load by directly pressing the pressure measurement member 70 in the center region passing through the axial line S.

Further, in the present embodiment, the heat insulating member 60, the first electrode 71, the second electrode 73, and the insulating member 82 are formed to have substantially the same outer diameter dimension and substantially the same thickness dimension, that is, substantially the same shape in order to be fitted into the through hole 51 of the positioning member 51 and positioned on the axial line S, as illustrated in FIG. 5.

As illustrated in FIGS. 2 and 4, the lead wire 91 is electrically connected to the first electrode 71 of the pressure measurement member 70, passes through one notched groove 54 of the positioning member 50, one vertical groove 81a of the fixation member 81, and the through passage 13 of the external housing 10, and is guided to the connector 100 in a state where the lead wire 91 is led while being insulated from the external housing 10.

That is, the first electrode 71 is connected to a terminal 102 of the connector 100 through the lead wire 91 and is electrically connected to a ground side (negative side) of an electrical circuit through an external connector.

As illustrated in FIGS. 2 and 4, the lead wire 92 is electrically connected to the second electrode 73 of the pressure measurement member 70, passes through the other notched groove 54 of the positioning member 50, the other vertical groove 81a of the fixation member 81, and the through passage 13 of the external housing 10, and is guided to the connector 100 in a state where the lead wire 92 is led while being insulated from the external housing 10.

That is, the second electrode 73 is connected to a terminal 103 of the connector 100 through the lead wire 92 and is electrically connected to an output side (positive side) of the electrical circuit through the external connector.

As illustrated in FIG. 2, the connector 100 includes a coupling portion 101 coupled to the connector connection portion 16 of the external housing 10, the terminal 102 which is fixed to the coupling portion 101 and electrically connected to the lead wire 91, and the terminal 103 which is fixed to the coupling portion 101 through an insulating member and electrically connected to the lead wire 92.

The terminals 102 and 103 are respectively connected to connection terminals of the external connector.

Next, an operation of incorporating the pressure sensor having the above-described configuration will be described.

When the operation is performed, the external housing 10, the sub-housing 20, the diaphragm 30, the holding plate 40, the positioning member 50, the heat insulating member 60, the first electrode 71, the piezoelectric element 72, the second electrode 73, the fixation member 81, the insulating member 82, the lead wire 91, the lead wire 92, and the connector 100 are prepared.

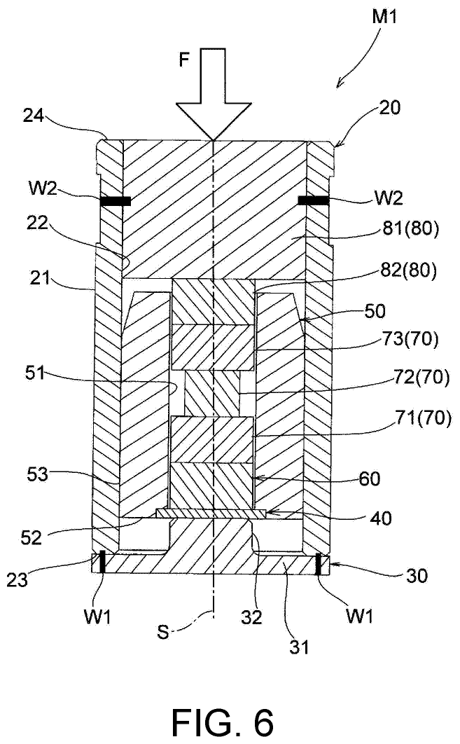

First, as illustrated in FIG. 6, the flexible plate-shaped portion 31 of the diaphragm 30 is fixed to the tip end surface 23 of the sub-housing 20 using welding W1.

Subsequently, the positioning member 50 is fitted into the inner peripheral wall 22 of the sub-housing 20 in a state where the holding plate 40 is fitted into the fitting concave portion 52, and the holding plate 40 abuts against the protrusion portion 32 of the diaphragm 30.

Subsequently, the heat insulating member 60, the first electrode 71 to which the lead wire 91 is connected, the piezoelectric element 72, the second electrode 73 to which the lead wire 92 is connected, and the insulating member 82 are sequentially stacked and fitted into the through hole 51 of the positioning member 50.

Subsequently, the fixation member 81 is fitted into the inner peripheral wall 22 of the sub-housing 20 and abuts against the insulating member 82.

Subsequently, a load F is applied to the fixation member 81 from the outside in the direction of the axial line S by using a tool, a load applying device, or the like, and the pressure measurement member 70 is pressed toward the diaphragm 30, whereby a preload is imparted.

Further, in a state where a preload is imparted, the fixation member 81 is fixed to a region in which the sub-housing 20 is formed to have a small outer diameter, using welding W2.

Thereby, as illustrated in FIGS. 4 and 5, a sensor module M1 is formed.

Here, since the welding W2 is applied to a region in which the sub-housing 20 has a small outer diameter, sputtering is not caught by the fitting inner peripheral wall 11 of the external housing 10 even when the sputtering occurs at the time of the welding W2, and thus it is possible to easily fit the sensor module M1 into the external housing 10.

In addition, a method of incorporating the sensor module M1 is not limited to the above-described procedure, and the holding plate 40, the heat insulating member 60, the first electrode 71, the piezoelectric element 72, the second electrode 73, and the insulating member 82 may be incorporated into the positioning member 50 in advance, and the positioning member 50 having the above-described various components incorporated thereinto is fitted into the sub-housing 20, so that the fixation member 81 is fixed to the sub-housing 20 using welding or the like in a state where a preload is imparted thereto.

Subsequently, the sensor module M1 is incorporated into the external housing 10. That is, the lead wires 91 and 92 pass through the through passage 13 of the external housing 10 and the sub-housing 20 is fitted into the fitting inner peripheral wall 11 of the external housing 10, so that the back-side end surface 24 abuts against the stepped portion 12.

Thereafter, the sub-housing 20 is fixed to the external housing 10 using welding.

In addition, a location where welding of the sub-housing 20 is performed may be any region such as a tip end side region, a back side region, or an intermediate region in the direction of the axial line S.

Subsequently, the coupling portion 101 is fixed to the connector connection portion 16 of the external housing 10.

Subsequently, the lead wire 91 is connected to the terminal 102, and then the terminal 102 is fixed to the coupling portion 101.

Subsequently, the lead wire 92 is connected to the terminal 103, and then the terminal 103 is fixed to the terminal 102 through an insulating member.

Thereby, the connector 100 is fixed to the external housing 10.

Thus, the incorporating of the pressure sensor is completed.

In addition, the above-described incorporating procedure is merely an example and is not limited thereto, and other incorporating procedures may be adopted.

According to the pressure sensor of the first embodiment, since a center region centering on the axial line S of the preload imparting member 80 is formed to have a solid form, a compression load passing through the axial line S can be exerted on the pressure measurement member 70. Therefore, pressure resistance is improved, and thus it is possible to impart a desired preload to the pressure measurement member 70. Since the preload imparting member 80 has a solid form, it is possible to achieve a reduction in diameter as compared to a preload imparting member having a hollow shape of the related art.

In addition, since the positioning member 50 fitted into the sub-housing 20 is adopted, it is possible to position the pressure measurement member 70 and the insulating member 82 on the axial line S with high accuracy and to reliably prevent the first electrode 71 and the second electrode 73 from being short-circuited by the positioning member 50 being formed of an insulating material.

In addition, the housing includes the external housing 10 and the sub-housing 20 which is fitted into the external housing 10 and fixed thereto, and the diaphragm 30, the holding plate 40, the positioning member 50, the heat insulating member 60, the pressure measurement member 70, and the preload imparting member 80 are disposed in the sub-housing 20.

Accordingly, it is possible to form the sensor module M1 by previously incorporating the diaphragm 30, the holding plate 40, the positioning member 50, the heat insulating member 60, the pressure measurement member 70, and the preload imparting member 80 into the sub-housing 20.

Therefore, in a case where an attachment shape and the like vary depending on an application target, it is possible to share the sensor module M1 by setting only the external housing 10 for each application target.

Further, since the heat insulating member 60 interposed between the diaphragm 30 and the first electrode 71 is adopted, heat transferred to the diaphragm 30 is insulated by the heat insulating member 60, and thus heat transfer from the diaphragm 30 to the first electrode 71 and the piezoelectric element 72 is suppressed. Therefore, the influence of heat on the piezoelectric element 72 is suppressed, so that it is possible to prevent a fluctuation in a reference point (zero point) of a sensor output and to obtain predetermined sensor accuracy.

Here, the heat insulating member 60 is formed of an insulating material, the first electrode 71 is directly connected to an electrical circuit through the lead wire 91, and the second electrode 73 is directly connected to the electrical circuit through the lead wire 92, and thus it is possible to prevent the generation of a leak current concerned in a case where the first electrode is connected to a ground of a cylinder head of an engine, or the like through a housing and to maintain predetermined sensor characteristics.

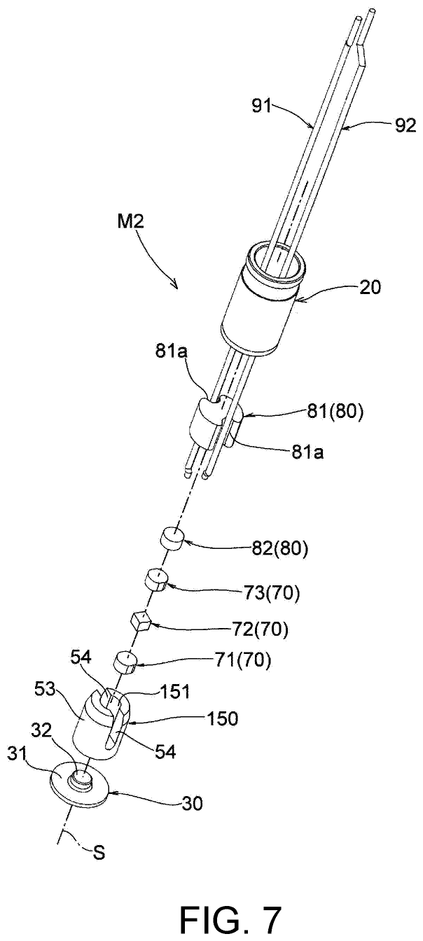

FIGS. 7 to 10 illustrate a pressure sensor according to a second embodiment of the disclosure in which the positioning member, the holding plate, and the heat insulating member in the sensor module M1 according to the above-described first embodiment are changed. Therefore, the same components as those of the pressure sensor according to the above-described first embodiment are denoted by the same reference numeral and signs, and description thereof will be omitted.

The pressure sensor according to the second embodiment includes an external housing 10 and a sub-housing 20, a diaphragm 30, a positioning member 150, a pressure measurement member 70, a preload imparting member 80, a lead wire 91, a lead wire 92, and a connector 100.

The positioning member 150 is formed to have a substantially bottomed cylindrical shape extending in the direction of the axial line S by using an insulating material having an electrical insulating property and a thermal insulating property, and includes a cylindrical concave portion 151 centering on an axial line S, a flat plate portion 152 interposed between a protrusion portion 32 and a first electrode 71, an outer peripheral surface 53, and two notched grooves 54.

In addition, an insulating material for forming the positioning member 150 is the same as the above-described heat insulating member 60 and positioning member 50.

In addition, the positioning member 150, which is fitted to an inner peripheral wall 22 of the sub-housing 20 and is configured such that the flat plate portion 152 abuts against the protrusion portion 32, positions and holds the pressure measurement member 70 constituted by the first electrode 71, a piezoelectric element 72, and a second electrode 73, and the insulating member 82 in a stacked state inside a concave portion 151.

That is, the positioning member 150 is fitted to the inside of the sub-housing 20 constituting a portion of the housing. The pressure measurement member 70 and the insulating member 82 are fitted in the concave portion 151 so as to be positioned on the axial line S.

Therefore, it is possible to position the first electrode 71, the piezoelectric element 72, and the second electrode 73 constituting the pressure measurement member 70 on the axial line S with the positioning member 150 as a reference while securing insulating properties of both the electrodes to easily incorporate these components.

In addition, the flat plate portion 152 of the positioning member 150 is interposed between the diaphragm 30 and the first electrode 71 to play a role as a heat insulating member for suppressing heat transfer from the diaphragm 30 to the first electrode 71.

That is, the positioning member 150 positions the pressure measurement member 70 on the axial line S to hole the pressure measurement member and also serves as a heat insulating member which is interposed between the diaphragm 30 and the first electrode 71.

In this manner, since the positioning member 150 is formed to serve as a heat insulating member, a holding plate 40 and a heat insulating member 60 in the first embodiment are not required, and it is possible to reduce the number of components as compared to a case where a heat insulating member is provided separately.

In addition, since the flat plate portion 152 is formed integrally as a portion of the positioning member 150, the entire positioning member 150 functions as a heat insulating member having a high heat capacity.

Next, an operation of incorporating the pressure sensor having the above-described configuration will be described.

When the operation is performed, the external housing 10, the sub-housing 20, the diaphragm 30, the positioning member 150, the first electrode 71, the piezoelectric element 72, the second electrode 73, the fixation member 81, the insulating member 82, the lead wire 91, the lead wire 92, and the connector 100 are prepared.

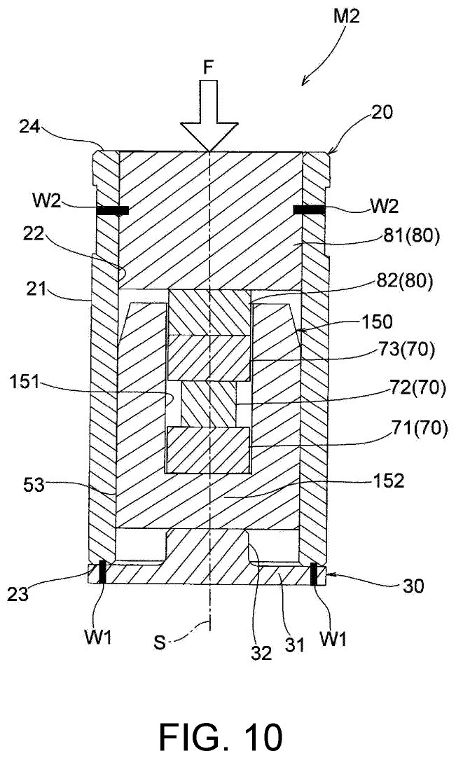

First, as illustrated in FIG. 10, the flexible plate-shaped portion 31 of the diaphragm 30 is fixed to the tip end surface 23 of the sub-housing 20 using the welding W1.

Subsequently, the positioning member 150 is fitted into the inner peripheral wall 22 of the sub-housing 20.

Subsequently, the first electrode 71 to which the lead wire 91 is connected, the piezoelectric element 72, the second electrode 73 to which the lead wire 92 is connected, and the insulating member 82 are sequentially stacked and fitted into the concave portion 151 of the positioning member 150.

Subsequently, the fixation member 81 is fitted into the inner peripheral wall 22 of the sub-housing 20 and abuts against the insulating member 82.

Subsequently, a load F is applied to the fixation member 81 from the outside in the direction of the axial line S by using a tool, a load applying device, or the like, and the pressure measurement member 70 is pressed toward the diaphragm 30, whereby a preload is imparted.

In addition, in a state where a preload is imparted, the fixation member 81 is fixed to a region in which the sub-housing 20 is formed to have a small outer diameter, using the welding W2.

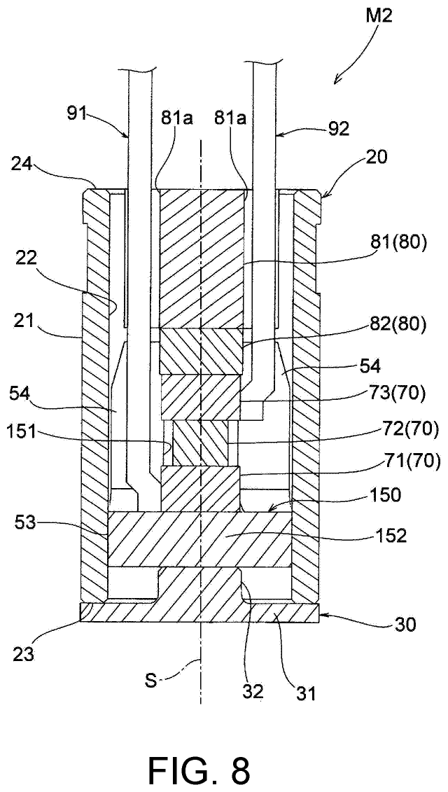

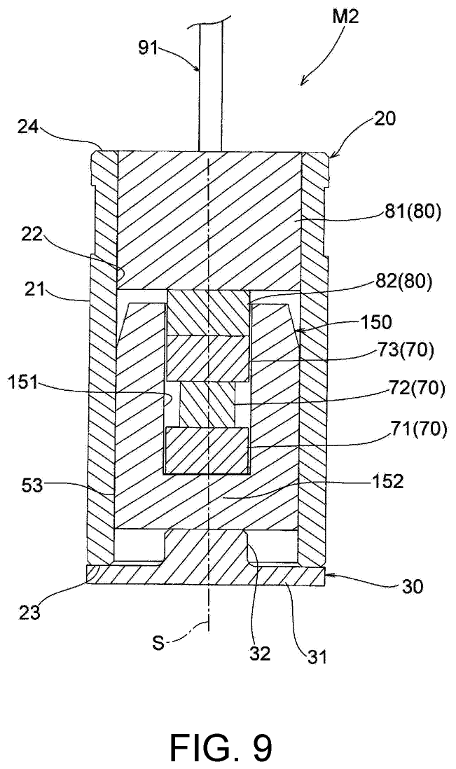

Thereby, as illustrated in FIGS. 8 and 9, a sensor module M2 is formed.

Here, since the welding W2 is applied to a region in which the sub-housing 20 has a small outer diameter, sputtering is not caught by the fitting inner peripheral wall 11 of the external housing 10 even when sputtering occurs at the time of the welding W2, and thus it is possible to easily fit the sensor module M2 into the external housing 10.

In addition, a method of incorporating the sensor module M2 is not limited to the above-described procedure, and the first electrode 71, the piezoelectric element 72, the second electrode 73, and the insulating member 82 may be incorporated into the positioning member 150 in advance, and the positioning member 150 having the above-described various components incorporated thereinto is fitted into the sub-housing 20, so that the fixation member 81 is fixed to the sub-housing 20 using welding in a state where a preload is imparted thereto.

Subsequently, the sensor module M2 is incorporated into the external housing 10.

Thereafter, the incorporating of the pressure sensor is completed through the same procedure as the operation according to the above-described first embodiment.

In addition, the above-described incorporating procedure is merely an example and is not limited thereto, and other incorporating procedures may be adopted.

According to the pressure sensor of the above-described second embodiment, since the center region centering on the axial line S of the preload imparting member 80 is formed to have a solid form, a compression load passing through the axial line S can be exerted on the pressure measurement member 70. Therefore, pressure resistance is improved, and thus it is possible to impart a desired preload to the pressure measurement member 70. Since the preload imparting member 80 has a solid form, it is possible to achieve a reduction in diameter as compared to a preload imparting member having a hollow shape of the related art.

In addition, since the positioning member 150 fitted into the sub-housing 20 is adopted, it is possible to position the pressure measurement member 70 and the insulating member 82 on the axial line S with high accuracy and to reliably prevent the first electrode 71 and the second electrode 73 from being short-circuited by the positioning member 150 being formed of an insulating material.

In addition, the housing includes the external housing 10 and the sub-housing 20 which is fitted into the external housing 10 and fixed thereto, and the diaphragm 30, the positioning member 150, the pressure measurement member 70, and the preload imparting member 80 are disposed in the sub-housing 20.

That is, it is possible to form a sensor module M2 by previously incorporating the diaphragm 30, the positioning member 150 serving as a heat insulating member, the pressure measurement member 70, and the preload imparting member 80 into the sub-housing 20.

Therefore, in a case where an attachment shape and the like vary depending on an application target, it is possible to share the sensor module M2 by setting only the external housing 10 for each application target.

Further, since the flat plate portion 152 of the positioning member 150 is adopted to function as a heat insulating member interposed between the diaphragm 30 and the first electrode 71, heat transferred to the diaphragm 30 is insulated by the entirety of the flat plate portion 152 or the positioning member 150, and thus heat transfer from the diaphragm 30 to the first electrode 71 and the piezoelectric element 72 is suppressed. Therefore, the influence of heat on the piezoelectric element 72 is suppressed, so that it is possible to prevent a fluctuation in a reference point (zero point) of a sensor output and to obtain predetermined sensor accuracy.

In particular, the positioning member 150 serves as a heat insulating member, and thus it is possible to reduce the number of components and simplify a structure.

In addition, since the positioning member 150 is formed of an insulating material, the first electrode 71 is directly connected to an electrical circuit through the lead wire 91, and the second electrode 73 is directly connected to the electrical circuit through the lead wire 92, a leak current is not generated and predetermined sensor characteristics can be maintained similar to the first embodiment.

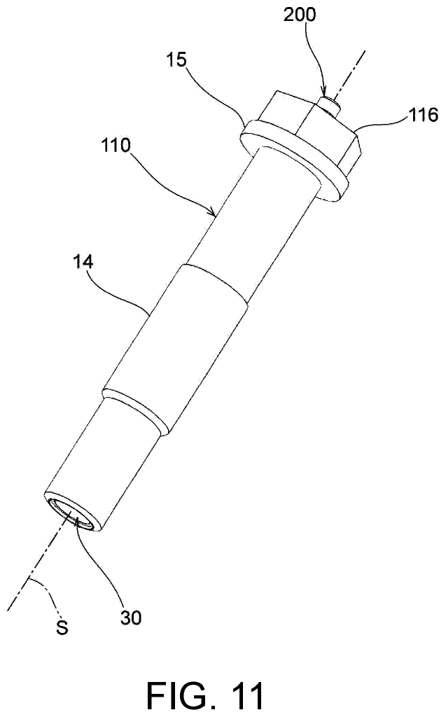

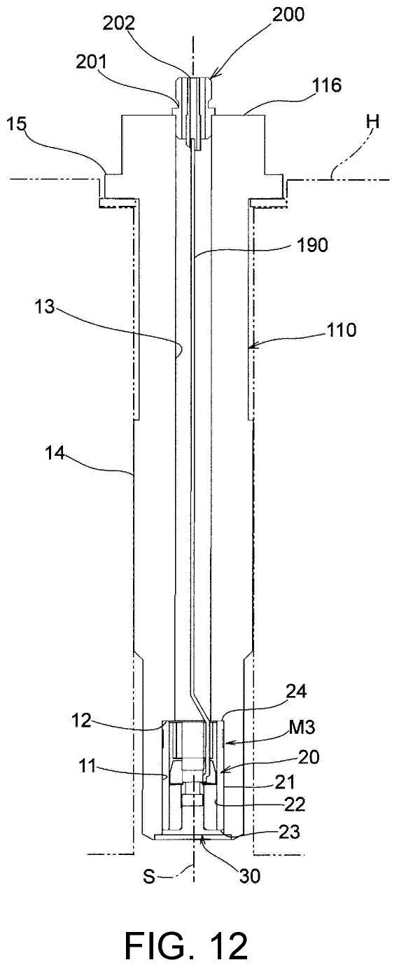

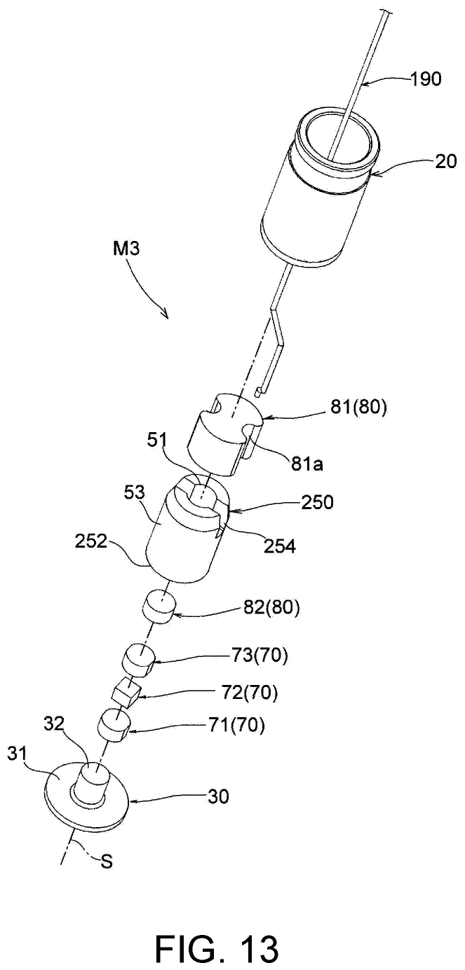

FIGS. 11 to 16 illustrate a pressure sensor according to a third embodiment of the disclosure. Components the same as those of the pressure sensor according to the above-described first embodiment are denoted by the same reference numeral and signs, and description thereof will be omitted.

The pressure sensor according to the third embodiment includes an external housing 110 and a sub-housing 20 as tubular housings defining an axial line S, a diaphragm 30, a positioning member 250, a pressure measurement member 70, a preload imparting member 80, a lead wire 190 as a conductor, and a connector 200.

An external housing 110 is formed to have a cylindrical shape extending in the direction of the axial line S by using a metal material such as precipitation hardening or ferritic stainless steel, and includes a fitting inner peripheral wall 11, a stepped portion 12, a through passage 13, a male screw portion 14, a flange portion 15, and a connector connection portion 116.

The lead wire 190 is electrically connected to the second electrode 73 of the pressure measurement member 70, passes through one notched groove 254 of the positioning member 250, one vertical groove 81a of the fixation member 81, and the through passage 13 of the external housing 110, and is guided to the connector 200 in a state where the lead wire 190 is led while being insulated from the external housing 110.

That is, the second electrode 73 is connected to the terminal 202 of the connector 200 through the lead wire 190 and is electrically connected to an output side (positive side) of the electrical circuit through the external connector.

On the other hand, the first electrode 71 of the pressure measurement member 70 is disposed so as to abut against the protrusion portion 32 of the diaphragm 30.

That is, the first electrode 71 is electrically connected to a ground side (negative side) of an electrical circuit through the diaphragm 30 and the housings (the external housing 110 and the sub-housing 20).

The connector 200 includes a coupling portion 201 coupled to the connector connection portion 116 of the external housing 110, and the terminal 202 which is fixed to the coupling portion 201 through an insulating member and electrically connected to the lead wire 190. The terminal 202 is connected to a connection terminal of the external connector.

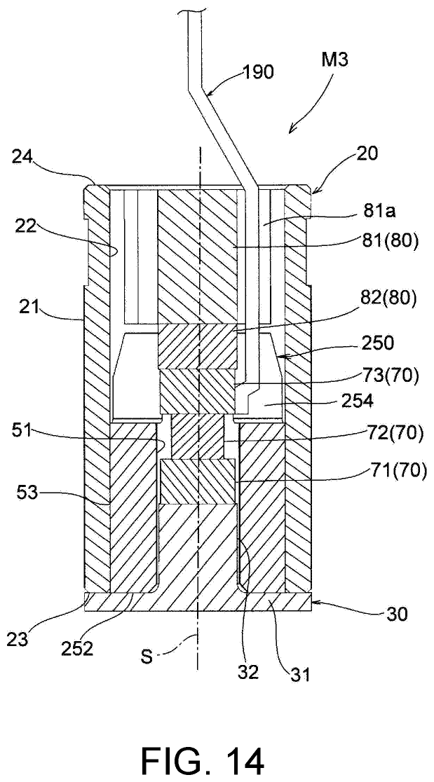

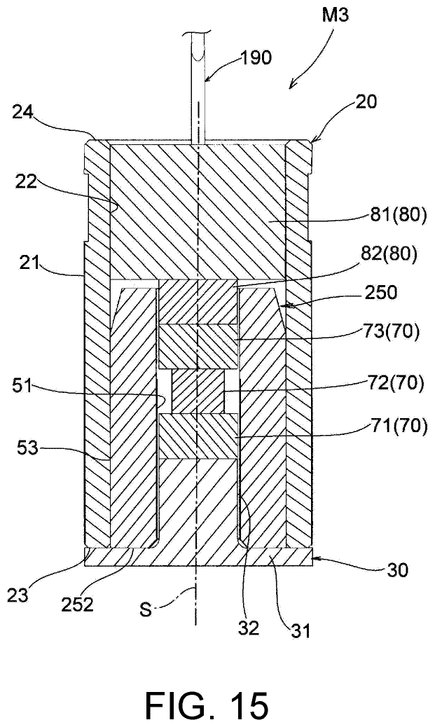

As illustrated in FIGS. 14 and 15, the positioning member 250 is formed to have a substantially cylindrical shape extending in the direction of the axial line S by using an insulating material having an electrical insulating property and a thermal insulating property, and includes a cylindrical through hole 51 centering on the axial line S, an end surface 252 which is in contact with a flexible plate-shaped portion 31 of the diaphragm 30, an outer peripheral surface 53, and two notched grooves 254 as punched portions.

The two notched grooves 254 have the same depth dimension in the direction of the axial line S and are provided at positions point-symmetrical to and separated from each other by 180 degrees around the axial line S. Therefore, in a case where the lead wire 190 passes through the notched grooves, any one notched groove 254 can be used.

That is, the positioning member 250 is fitted to the inside of the sub-housing 20 constituting a portion of the housing. The pressure measurement member 70 and the insulating member 82 are fitted in the through hole 51 so as to be positioned on the axial line S.

In addition, an insulating material for forming the positioning member 250 is the same as the above-described positioning members 50 and 150.

In addition, the positioning member 250 is fitted to an inner peripheral wall 22 of the sub-housing 20 and positions and holds the protrusion portion 32 of the diaphragm 30, the pressure measurement member 70 constituted by the first electrode 71, a piezoelectric element 72, and a second electrode 73, and the insulating member 82 in a stacked state inside the through hole 51.

That is, the positioning member 250 is fitted to the inside of the sub-housing 20 constituting a portion of the housing. The protrusion portion 32, the pressure measurement member 70, and the insulating member 82 are fitted in the through hole 51 so as to be positioned on the axial line S.

Therefore, is possible to position the protrusion portion 32, and first electrode 71, the piezoelectric element 72 and the second electrode 73 that constitute the pressure measurement member 70 on the axial line S with the positioning member 250 as a reference while securing insulating properties of both the electrodes to easily incorporate these components.

Next, an operation of incorporating the pressure sensor having the above-described configuration will be described.

When the operation is performed, the external housing 110, the sub-housing 20, the diaphragm 30, the positioning member 250, the first electrode 71, the piezoelectric element 72, the second electrode 73, the fixation member 81, the insulating member 82, the lead wire 190, and the connector 200 are prepared.

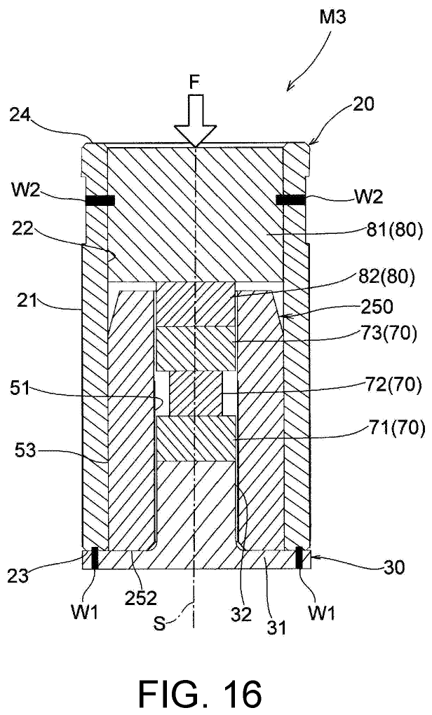

First, as illustrated in FIG. 16, the flexible plate-shaped portion 31 of the diaphragm 30 is fixed to the tip end surface 23 of the sub-housing 20 using welding W1.

Subsequently, the positioning member 250 is fitted into the inner peripheral wall 22 of the sub-housing 20, and the protrusion portion 32 is fitted into the through hole 51.

Subsequently, the first electrode 71, the piezoelectric element 72, the second electrode 73 to which the lead wire 190 is connected, and the insulating member 82 are sequentially stacked and fitted into the through hole 51 of the positioning member 250.

Subsequently, the fixation member 81 is fitted into the inner peripheral wall 22 of the sub-housing 20 and abuts against the insulating member 82.

Subsequently, a load F is applied to the fixation member 81 from the outside in the direction of the axial line S by using a tool, a load applying device, or the like, and the pressure measurement member 70 is pressed toward the diaphragm 30, whereby a preload is imparted.

Further, in a state where a preload is imparted, the fixation member 81 is fixed to a region in which the sub-housing 20 is formed to have a small outer diameter, using welding W2.

Thereby, as illustrated in FIGS. 14 and 15, a sensor module M3 is formed.

Here, since the welding W2 is applied to a region in which the sub-housing 20 has a small outer diameter, sputtering is not caught by the fitting inner peripheral wall 11 of the external housing 110 even when sputtering occurs at the time of the welding W2, and thus it is possible to easily fit the sensor module M3 into the external housing 110.

In addition, a method of incorporating the sensor module M3 is not limited to the above-described procedure, and the first electrode 71, the piezoelectric element 72, the second electrode 73, and the insulating member 82 may be incorporated into the positioning member 250 in advance, and the positioning member 250 having the above-described various components incorporated thereinto is fitted into the sub-housing 20, so that the fixation member 81 is fixed to the sub-housing 20 using welding in a state where a preload is imparted thereto.

Subsequently, the sensor module M3 is incorporated into the external housing 110. That is, the lead wire 190 passes through the through passage 13 of the external housing 110, and the sub-housing 20 is fitted into the fitting inner peripheral wall 11 of the external housing 110, so that a back-side end surface 24 abuts against the stepped portion 12.

Thereafter, the sub-housing 20 is fixed to the external housing 110 using welding.

In addition, a location where welding of the sub-housing 20 is performed may be any region such as a tip end side region, a back side region, or an intermediate region in the direction of the axial line S.

Subsequently, the lead wire 190 is connected to the terminal 202 of the connector 200, and the coupling portion 201 is fixed to the connector connection portion 116 of the external housing 110. Thereby, the connector 200 is fixed to the external housing 110. Thus, the incorporating of the pressure sensor is completed.

In addition, the above-described incorporating procedure is merely an example and is not limited thereto, and other incorporating procedures may be adopted.

According to the pressure sensor of the above-described third embodiment, since the center region centering on the axial line S of the preload imparting member 80 is formed to have a solid form, a compression load passing through the axial line S can be exerted on the pressure measurement member 70. Therefore, pressure resistance is improved, and thus it is possible to impart a desired preload to the pressure measurement member 70. Since the preload imparting member 80 has a solid form, it is possible to achieve a reduction in diameter as compared to a preload imparting member having a hollow shape of the related art.

In addition, since the positioning member 250 fitted into the sub-housing 20 is adopted, it is possible to position the pressure measurement member 70 and the insulating member 82 on the axial line S with high accuracy and to reliably prevent the first electrode 71 and the second electrode 73 from being short-circuited by the positioning member 250 being formed of an insulating material.

In addition, the housing includes the external housing 110 and the sub-housing 20 which is fitted into the external housing 110 and fixed thereto, and the diaphragm 30, the positioning member 250, the pressure measurement member 70, and the preload imparting member 80 are disposed in the sub-housing 20.

That is, it is possible to form a sensor module M3 by previously incorporating the diaphragm 30, the positioning member 250, the pressure measurement member 70, and the preload imparting member 80 into the sub-housing 20.

Therefore, in a case where an attachment shape and the like vary depending on an application target, it is possible to share the sensor module M3 by setting only the external housing 110 for each application target.

In the above-described embodiment, the diaphragm 30 integrally including the flexible plate-shaped portion 31 and the protrusion portion 32 has been described as a diaphragm. However, the disclosure is not limited thereto, and a configuration in which the flexible plate-shaped portion 31 and the protrusion portion 32 are formed separately so that the flexible plate-shaped portion 31 functions as a diaphragm and the protrusion portion 32 functions as a force transfer member may be adopted.

In the above-described embodiment, a configuration including the external housing 10 or 110 and the sub-housing 20 has been described as housings. However, the disclosure is not limited thereto, and one housing may be adopted.

As described above, the pressure sensors of the disclosure can improve pressure resistance to impart a desired preload to a piezoelectric element, secure predetermined sensor accuracy, and suppress the influence of heat. Therefore, the pressure sensors can be particularly applied as a pressure sensor that detects a pressure of a high temperature pressured medium such as a combustion gas inside a combustion chamber of an engine and is also useful as a pressure sensor that detects a pressure of a pressured medium other than a combustion gas or another pressured medium.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A pressure sensor comprising:
a tubular housing which defines an axial line;
a diaphragm which is fixed to a tip end of the housing and exposed to a pressured medium;
a pressure measurement member which is constituted by a first electrode, a piezoelectric element, and a second electrode which are sequentially stacked in a direction of the axial line from a tip end side inside the housing; and
a preload imparting member which is disposed inside the housing and is configured such that a center region centering on the axial line is configured to have a solid form to impart a preload by pressing the pressure measurement member toward the diaphragm.

2. The pressure sensor according to claim 1, wherein
the diaphragm includes a flexible plate-shaped portion fixed to the housing and a protrusion portion protruding toward an inside of the housing from a center region of the flexible plate-shaped portion, and
the preload imparting member is configured so as to press the pressure measurement member toward the protrusion portion.

3. The pressure sensor according to claim 1, wherein the preload imparting member includes a fixation member fixed to the housing and an insulating member disposed between the fixation member and the second electrode.

4. The pressure sensor according to claim 2, wherein the preload imparting member includes a fixation member fixed to the housing and an insulating member disposed between the fixation member and the second electrode.

5. The pressure sensor according to claim 3, wherein the fixation member has a punched portion in an outer peripheral region outside the center region centering on the axial line to allow a conductor, which is connected to the first electrode or the second electrode, to pass therethrough.

6. The pressure sensor according to claim 1, comprising:
a positioning member which is fitted to an inside of the housing, and the pressure measurement member is fitted to the positioning member so as to be positioned on the axial line.

7. The pressure sensor according to claim 2, comprising:
a positioning member which is fitted to an inside of the housing, and the pressure measurement member is fitted to the positioning member so as to be positioned on the axial line.

8. The pressure sensor according to claim 3, comprising:
a positioning member which is fitted to an inside of the housing, and fits the pressure measurement member is fitted to the positioning member so as to be positioned on the axial line.

9. The pressure sensor according to claim 5, comprising:
a positioning member which is fitted to an inside of the housing, and fits the pressure measurement member is fitted to the positioning member so as to be positioned on the axial line.

10. The pressure sensor according to claim 6, wherein
the preload imparting member includes a fixation member fixed to the housing and an insulating member disposed between the fixation member and the second electrode, and
the positioning member is formed of an insulating material and has a tubular shape defining a through hole into which the pressure measurement member and the insulating member are fitted.

11. The pressure sensor according to claim 10, comprising:
a heat insulating member which is interposed between the diaphragm and the first electrode,
wherein the heat-insulating member is fitted into the through hole of the positioning member.

12. The pressure sensor according to claim 6, wherein
the preload imparting member includes a fixation member fixed to the housing and an insulating member disposed between the fixation member and the second electrode, and
the positioning member includes an insulating material and has a bottomed tubular shape defining a concave portion into which the pressure measurement member and the insulating member are fitted.

13. The pressure sensor according to claim 12, comprising:
a heat insulating member which is interposed between the diaphragm and the first electrode,
wherein the positioning member serves as the heat-insulating member.

14. The pressure sensor according to claim 6, wherein the positioning member has a punched portion configured to allow a conductor, which is connected to the first electrode or the second electrode, to pass therethrough.

15. The pressure sensor according to claim 10, wherein the positioning member has a punched portion configured to allow a conductor, which is connected to the first electrode or the second electrode, to pass therethrough.

16. The pressure sensor according to claim 11, wherein the positioning member has a punched portion configured to allow a conductor, which is connected to the first electrode or the second electrode, to pass therethrough.

17. The pressure sensor according to claim 12, wherein the positioning member has a punched portion configured to allow a conductor, which is connected to the first electrode or the second electrode, to pass therethrough.

18. The pressure sensor according to claim 13, wherein the positioning member has a punched portion configured to allow a conductor, which is connected to the first electrode or the second electrode, to pass therethrough.

19. The pressure sensor according to claim 1, comprising:
a positioning member which is fitted to an inside of the housing, and the pressure measurement member is fitted to the positioning member so as to be positioned on the axial line,
wherein the housing includes an external housing and a sub-housing which is fitted into and fixed to the external housing, and
the diaphragm, the positioning member, the pressure measurement member, and the preload imparting member are disposed inside the sub-housing.

20. The pressure sensor according to claim 2, comprising:
a positioning member which is fitted to an inside of the housing, and the pressure measurement member is fitted to the positioning member so as to be positioned on the axial line,
wherein the housing includes an external housing and a sub-housing which is fitted into and fixed to the external housing, and
the diaphragm, the positioning member, the pressure measurement member, and the preload imparting member are disposed inside the sub-housing.
